(19) United States
(12) Patent Application Publication
(10) Pub. No.: US 2025/0284767 A1
(43) Pub. Date: Sep. 11, 2025

(54) MATRIX MULTIPLICATION PERFORMED USING CONVOLUTION ENGINE WHICH INCLUDES ARRAY OF PROCESSING ELEMENTS

(71) Applicant: Tesla, Inc., Austin, TX (US)

(72) Inventors: Gagandeep Sachdev, Austin, TX (US); Peter Sassone, Austin, TX (US); Jeremy Tanumihardjo, Austin, TX (US)

(21) Appl. No.: 18/859,039

(22) PCT Filed: Apr. 27, 2023
(86) PCT No.: PCT/US2023/020213

§ 371 Date: Oct. 22, 2024

Related U.S. Application Data
(60) Provisional application No. 63/336,586, filed on Apr. 29, 2022.

(51) Int. Cl. G06F 17/16; G06F 17/15

(52) U.S. Cl. CPC G06F 17/16; G06F 17/153

(57) ABSTRACT

An example matrix processor includes processing elements arranged as a grid, with the matrix processor being configured to receive a first matrix and a second matrix, wherein the first matrix is to be multiplied by the second matrix; transpose the second matrix; organize the second matrix into a plurality of columns, wherein each column is a row of the second matrix; and over one or more cycles, sequentially provide the columns of the second matrix and the rows of the first matrix to the processing elements, wherein the processing elements are configured as multiply-accumulate units (MAC units), and wherein a processing result is stored in the processing elements.

### CROSS-REFERENCE TO RELATED APPLICATIONS

This application claims priority to U.S. Prov. Patent App. No. 63/336,586 filed on Apr. 29, 2022 and titled “MATRIX MULTIPLICATION PERFORMED USING CONVOLUTION ENGINE WHICH INCLUDES ARRAY OF PROCESSING ELEMENTS,” the disclosure of which is hereby incorporated herein by reference in its entirety.

### BACKGROUND

### Technical Field

The present disclosure relates to matrix multiplication using hardware elements, and more particularly, matrix multiplication using a convolution engine.

### Description of Related Art

Neural networks are relied upon for disparate uses and are increasingly forming the underpinnings of technology. For example, a neural network may be leveraged to perform object classification on an image obtained via a user device (e.g., a smart phone). In this example, the neural network may represent a convolutional neural network which applies convolutional layers, pooling layers, and one or more fully-connected layers to classify objects depicted in the image. As another example, a neural network may be leveraged for translation of text between languages. For this example, the neural network may represent a recurrent-neural network.

Certain processors are typically used for applications of neural networks, for example to increase a speed at which they may be trained or used at inference time. An example processor may include a graphics processing unit (GPU) which allows for rapid computation of operations involving matrices, tensors, and so on. While GPUs can substantially speed-up processing of neural networks, for example as compared to central processing units (CPUs), they are typically designed for performance of common linear algebra operations. Thus, they are not designed to specifically speed up processing of neural networks.

### BRIEF DESCRIPTION OF THE DRAWINGS

FIG. 1A is a block diagram illustrating an example matrix processor (a convolution engine) which is included in an example matrix processor system.

FIG. 1B is a block diagram illustrating adjusting a particular matrix to enable matrix multiplication via the example matrix processor.

FIG. 2A illustrates two matrices which are to be multiplied via the example matrix processor.

FIG. 2B illustrates formatting of the two matrices to enable matrix multiplication.

FIG. 2C illustrates processing of the two matrices to enable matrix multiplication.

FIG. 3 is a flowchart of an example process for matrix multiplication using a convolution engine.

FIG. 4 is a block diagram illustrating an example vehicle which includes the matrix processor system.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

This application describes techniques to enable multiplying matrices using a convolution engine. As will be described, a matrix processor which includes a grid or array of processing elements may be used to multiply matrices. Example processing elements may include multiply-accumulator units (MAC units) which are arranged in the grid or array. In some embodiments, the grid or array may be a non-systolic array such that each MAC unit computes information locally without data movement within the grid or array.

A convolution engine may rely upon an array or grid of MAC units to efficiently compute convolutions between input data and weight data. Example input data may include input images, input feature maps, and so on. As known by those skilled in the art, the input data may have one or more input channels. For example, an input image may have three channels each associated with a particular color (e.g., red, green, blue). As another example, input feature maps may have 32, 64, 512, and so on, channels which are formed based on application of filters or kernels with 32, 64, 512, output channels. Similarly, the weight data may be associated with a number of output channels. Thus, when convolving input data with weight data, the output may be associated with the number of output channels.

Convolution may, as a simplified case, cause a two-dimensional filter to be convolved with a two-dimensional input. For example, the filter may be a 3×3 filter or kernel and the input may be a 12×12 input. In this example, the filter may be convolved with a 3×3 window in the input (e.g., the upper left portion of the input). As an example, the values included in the 3×3 filter are multiplied by corresponding values in the 3×3 window. These multiplications are summed, and a resulting value is determined in an output (e.g., a 12×12 output, assuming a stride of 1). The resulting value may be positioned at an upper left of the output. The filter is then slid, such as moved, over subsequent 3×3 windows in the input and resulting values determined for those windows.

In the above example, multiplications and additions are used to convolve the filter or kernel with the input. Certain processors, such as graphics processing units (GPUs), may be designed for rapid matrix operations. For example, these GPUs may be designed to rapidly compute a multiplication between matrices. However, neural networks (e.g., convolutional neural networks) require additional hardware or software complexity associated with rapidly computing convolutions. For example, the additional hardware or software complexity may be due to the use of sliding filters or kernels across input data. Typically, a matrix multiplication is performed between respective rows and columns of two matrices. In convolution, however, filters are element-wise multiplied with respective subsets of an input matrix. As another example, the additional hardware or software complexity may be due to use of multitudes of input and output channels which complicate techniques to organize and subsequently process input and weight data.

Thus, a matrix processor may be used which is designed, at least in part, to efficiently, and rapidly, process data for convolutional neural networks. The matrix processor, such as a convolution engine, may compute convolutions using input data associated with a first number of input channels and output data associated with a second number of output channels. As an example, the matrix processor may use input and weight data which has been organized or formatted to facilitate larger convolution operations. For example, input data may be in the form of a three-dimensional matrix (e.g., two-dimensional data across multiple input channels). In this example, the output data may be across multiple out channels. The matrix processor may thus process larger input data by merging, or flattening, each two-dimensional output channel into a vector such that the entire, or a substantial portion thereof, channel may be processed by the matrix processor. As another example, data may be efficiently re-used such that weight data may be shared across convolutions.

In some embodiments, the techniques described herein may apply the example matrix processor described in U.S. Pat. No. 11,157,287, U.S. Patent Pub. 2019/0026250, and U.S. Pat. No. 11,157,441, which are hereby incorporated by reference in their entirety and form part of this disclosure as if set forth herein.

While convolution engines, such as the above-described matrix processor, are performant with respect to processing convolutional neural networks, their specialized design may complicate other processing operations. As described above, a GPU may be designed for certain operations (e.g., matrix multiplication). To allow for efficient computation of neural networks, the GPU may need to have added hardware and/or software complexity. Similarly, a matrix processor may be designed for efficient computation of neural networks and require additional hardware and/or software complexity to perform other operations (e.g., matrix multiplication).

Described herein is an example of adjusting the operation of a convolution engine, such as a matrix processor, to perform matrix multiplication on arbitrary matrices. For example, the matrix processor may compute a matrix multiplication of a first matrix and a second matrix. In this example, the first matrix may be adjusted such that it is formatted in a manner similar to that of weight data. The matrix processor may then proceed normally using certain convolution parameters such that it rapidly generates a processing result (e.g., an output matrix). One example of a convolution parameter may include a filter size, a number of input or output channels, and so on.

### Block Diagrams

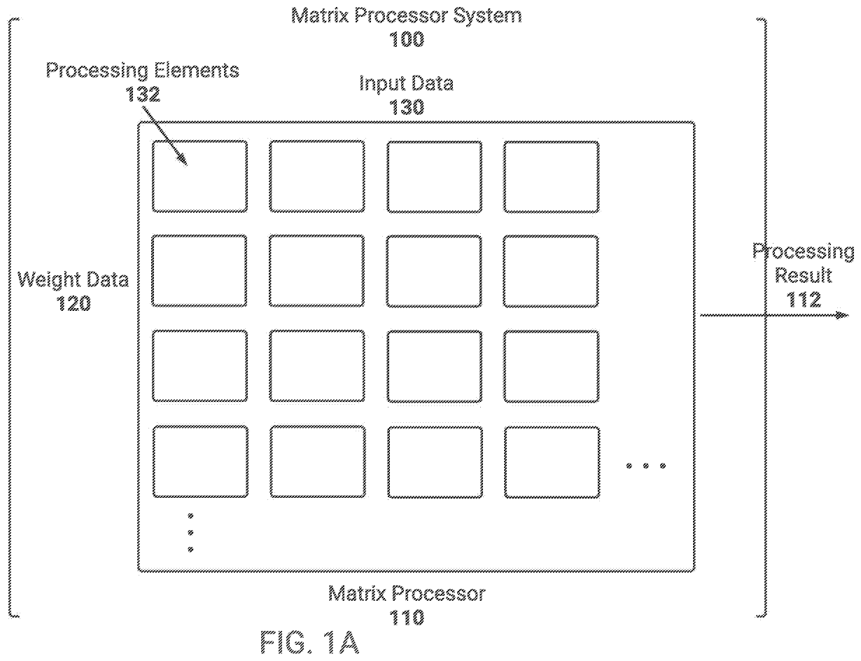

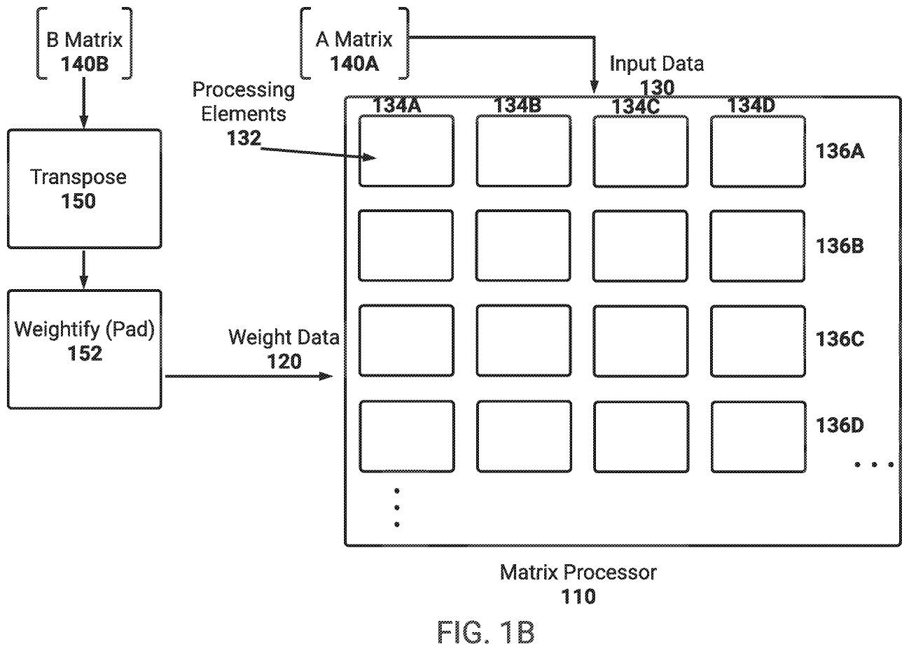

FIG. 1A is a block diagram illustrating an example matrix processor 110 (e.g., an example convolution engine) which is included in an example matrix processor system 100.

The matrix processor system 100 may be used, for example, to compute forward passes through layers of a neural network. In some embodiments, the neural network may represent a convolutional neural network in which image or video information is processed. In the illustrated example, input data 130 is being provided to the matrix processor 100 which includes an array or grid of processing elements 132. The processing elements may be, for example, multiply-accumulator units (MACs). In some embodiments, the array may be non-systolic such that over one or more cycles (e.g., clock cycles or processing cycles) each processing element multiplies and accumulates information.

The input data 130 may represent an input image, one or more feature maps, or a portion thereof. For example, the portion may represent a particular window of the input data which is to be multiplied by weight data (e.g., one or more kernels or filters). The input data 130 may also represent information being input into a layer of a neural network, such as a convolutional, transformer, or fully-connected network, which is to be multiplied with weight information (e.g., a weight matrix). The weight data 120 may represent one or more filters or kernels for one or more input channels. The weight data 120 may be loaded during a cycle, and optionally at a subsequent cycle different weight data 120 for a different output channel may be loaded.

The matrix processor 110 may determine a processing result 112 associated with the input data 130 and weight data 120. The processing result 122 may represent, for example, an output associated with one or more convolutions between the weight data 120 and input data 130.

Additional description related to an example matrix processor is included in U.S. Pat. No. 11,157,287, U.S. Patent Pub. 2019/0026250, and U.S. Pat. No. 11,157,441, which are each hereby incorporated by reference in their entirety and form part of this disclosure as if set forth herein.

FIG. 1B is a block diagram illustrating adjusting a particular matrix to enable matrix multiplication via the example matrix processor 110. The matrix processor 110, as described above, may be configured as a convolution engine such that it efficiently computes convolutions associated with input data and weight data. Thus, the matrix processor 110 may be configured to operate based on convolution parameters which are specified or determined according to the data being processed, based on a particular convolution layer being processed, based on instructions, and so on.

Example convolution parameters may include a size associated with filters along with information identifying a number of input channels, output channels, and so on. For example, a convolutional layer included in a convolutional neural network may apply a volume of filters (e.g., a 3×3×512 volume of filters). In this example, the convolutional layer may therefore apply 3×3 filters for each input channel and cause output of 512 channels. These filters may be formatted or organized as weight data 120, such that columns of weight data may be sequentially provided to the processing elements (e.g., over sequential clock cycles or processing cycles). In some embodiments, each column may represent filters associated with an output channel. The input data 130 may similarly be formatted or organized as rows where each row, in some embodiments, corresponds to pixels or elements associated with an output channel.

Due to the above-described formatting or organizing of information for weight data 120 and input data 130, multiplying two matrices (e.g., A matrix 140A and B matrix 140B) may not readily be suited for matrix processor 110. For example, due to the order or arrangement of weight data 120 the B matrix 140B may not be aligned for multiplication with input data 130.

In some embodiments, the matrix processor 110 may be configured to multiply the A matrix 140A and B matrix 140B based on adjusting the B matrix 140B and optionally setting particular convolution parameters. For example, the convolution parameters may be set such that the size associated with the filters is 1×1. Additionally, the B matrix 140B may be transposed 150 and optionally padded 152 (e.g., padded with zeros, which is also referred to herein as a weightify being applied).

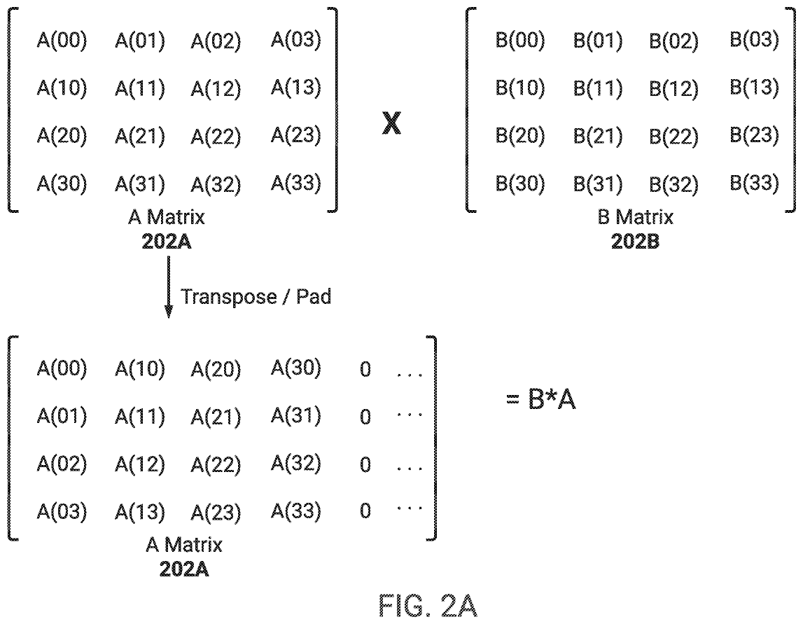

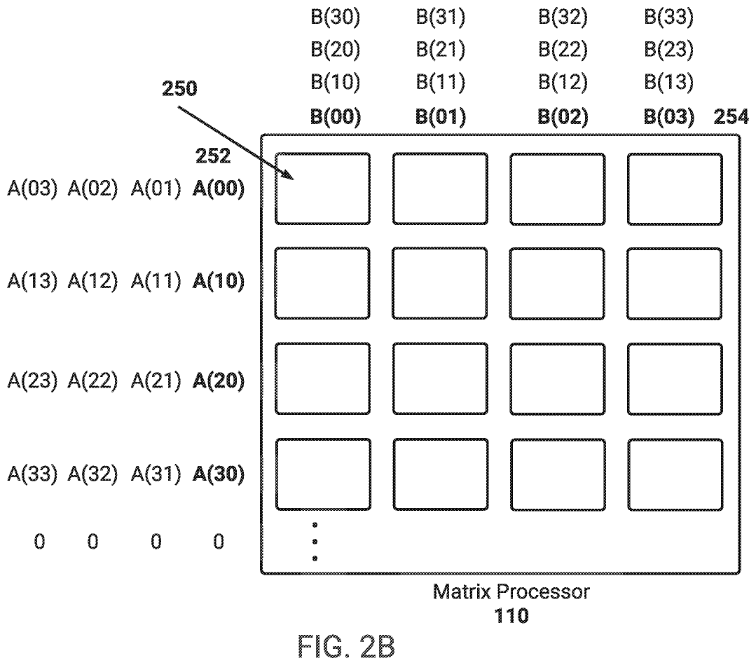

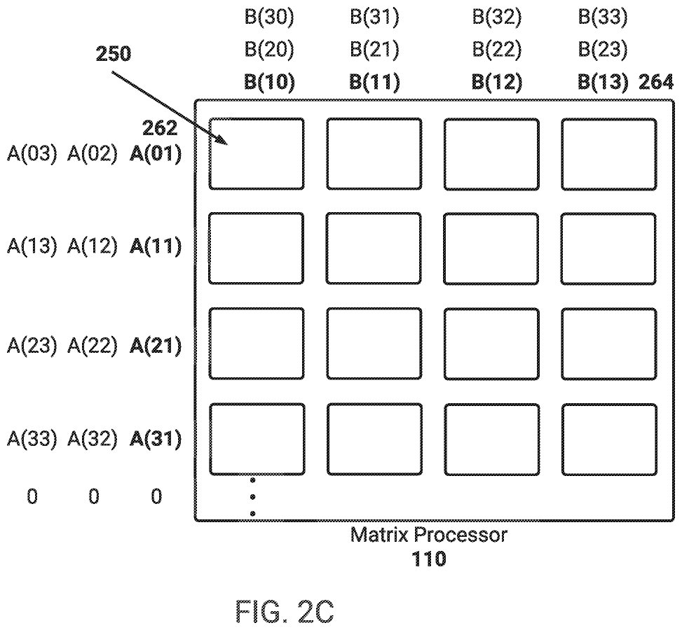

As will be described in FIGS. 2A-2C, B matrix 140B is transposed such that portions of the transposed B matrix 140B can be arranged as the weight data 120. For example, rows of the transposed B matrix 140B may be arranged as respective columns which are to be sequentially applied as weight data 120. In some embodiments, the transpose 150 may be required such that rows of the B matrix 140B can be used as weight data. In some embodiments, the matrix processor system 100 may provide row data in contrast to column data, such columns of the B matrix 140B are not readily able to be provided as weight data.

For example, the weight data 120 and input data 130 (e.g., [Y, X] matrices) may be flattened in memory (e.g., SRAM, DRAM, and so on) so that strips of X are contiguous. Thus, for the hardware, reading strips of X may be an easy contiguous read, but reading strips of Y may be harder and may require a complex strided load. For example, a first read from the input data 120 in a first cycle may be a natural read (e.g., [B00, B01, B02, . . . ] in FIG. 2B), which may be consecutive bytes in memory. Same with the second cycle read of [B10, B11, B12, . . . ]. However, a first read from the weight data (e.g., [A00, A10, A20, . . . ] in FIG. 2B) may not be consecutive in memory. For a large matrix, for example 1000×1000, each element may therefore, as an example, be a stride of 1000 away from the previous one in memory. Thus, in some embodiments the weight data is transposed such that the reads are easier (e.g., similar to the input data). In some embodiments, the weight data is not transposed, and the memory fetching may be efficient at arbitrarily large-stride loads and/or may be able to fetch columns of data.

Additionally, the B matrix 140B may optionally be padded or weightified based on a size of information the matrix processor 110 is configured to receive as weight data 120. For example, in some embodiments the B matrix 140B may have a particular number of elements or a particular number of bits. In this example, the B matrix 140B may be padded to bring the total elements of bits to a particular value (e.g., 32 bits, 32 elements). In some embodiments, if the total elements or bits is less than a first threshold number elements or bits (e.g., 32, 48, and so on) then the B matrix 140B may be padded to bring the total elements or bits to the first threshold. In some embodiments, if the total elements or bits is less than a second threshold number of elements or bits (e.g., 64, 96, and so on), but greater than the first threshold, then the B matrix 140B may be padded to bring the total elements or bits to the second threshold.

In some embodiments, if the B matrix 140B is greater than the above-described second threshold number of elements or bits then the B matrix 140B may be sliced or otherwise separated such that two sub-matrices are used. Each sub-matrix may include a portion of the B matrix 140B separated along a particular dimension (e.g., the sub-matrix may include a number of columns of data). In some embodiments, each sub-matrix may be of a size in accordance with the second threshold. Any remaining portion may be padded as described above.

Blocks 150 and 152 may be implemented as hardware elements of the matrix processor system 100. For example, hardware elements may be used to transpose the B matrix 140B (e.g., in a streaming context). In some embodiments, the matrix processor system 100 may receive a transposed 150 and optionally padded 152 matrix B 140B for processing.

The processing elements, for example at an initial cycle, may thus receive information from the weight data 120 and input data 130. For example, a first portion of the A matrix 140A may be provided to the processing elements 132. In this example, the first portion may represent a first row of the A matrix 140A. By way of example, if the first row has 4 elements then processing elements in the first column 134A will receive a first value in the row, processing elements in the second column 134B will receive a second value in the row, processing elements in the third column 134C will receive a third value in the row, and processing elements in the fourth column 134D will receive a fourth value in the row.

Similarly, at the initial cycle, the processing elements may receive a first portion of the transposed B matrix 140B. For example, a first column of the transposed B matrix 140B may be provided to the processing elements. In this example, processing elements in a first row 136A may receive a first value in the column, processing elements in a second row 136B may receive a second value in the column, processing elements in a third row 136C may receive a third value in the column, processing elements in a fourth row 136B may receive a fourth value in the column.

The processing elements 132 may then multiply the received value from the A matrix 140A and received value from the transposed B matrix 140B. Subsequently, remaining portions of the A matrix 140A and remaining portions of transposed B matrix 140B may then be sequentially provided to the processing elements for multiplication and accumulation.

FIG. 2A illustrates two matrices which are to be multiplied via the example matrix processor. In the illustrated example, A matrix 202A is illustrated as being a 4×4 matrix and B matrix 202B is illustrated as being another 4×4 matrix. As may be appreciated, the A matrix and B matrix may be different dimensions without adjusting the operation of the techniques described herein.

The A matrix 202A is illustrated as being transposed. Thus, the elements of the A matrix are flipped over a diagonal.

As illustrated, the result of the multiplication is the B matrix 202B*A matrix 202A (e.g., the order of the matrix multiplication).

FIG. 2B illustrates formatting of the two matrices to enable matrix multiplication. The matrix processor 110 is illustrated in the example, with processing elements arranged as an array of grid. For example, processing element 250 is illustrated as being the upper left of the array or grid.

The elements of the A matrix 202A are illustrated as being formatted as weight data. For example, a first column 252 of the weight data to be provided to the processing elements represents a first row (e.g., an upper row) of the transposed A matrix 202A illustrated in FIG. 2A. As illustrated, the columns of the weight data represent respective rows of the transposed A matrix 202A. These columns may be sequentially queued or fetched. Additionally, the B matrix 202B is formatted such that a first row (e.g., an upper row) of the B matrix 202A is the first row 254 of data to be provided to the processing elements. As illustrated, the rows represent rows of the B matrix 202A which are sequentially queued or fetched.

With respect to processing element 250, the element 250 may therefore receive the values A(00) and B(00). These values may be multiplied, for example by a multiply-accumulator unit. At a next cycle, illustrated in FIG. 2C, the result of the multiplication may be added to a subsequent multiplication between A(01) and B(10).

FIG. 2C illustrates processing of the two matrices to enable matrix multiplication. In the illustrated example, a next row of the transposed A matrix 202A is provided to the matrix processor 110 as column 262. Additionally, a next row of the B matrix 202B is provided to the matrix processor 110 as row 264.

Thus, processing element 250 computes a multiplication of A(01) and B(10). This multiplication is accumulated, such that processing element 250 stores the result of A(00)*B(00)+A(01)*B(10). While not illustrated, as may be appreciated the processing may continue such that all of the columns 270 and all of the rows 280 are received by the processing elements of the matrix processor 110 (e.g., the values in the columns 27 and rows 280 are loaded into the processing elements).

Each processing element may therefore store an output value associated with the multiplication of the A matrix 202A and B matrix 202B. For example, processing element 250 will store the result of A(00)*B(00)+A(01)*B(10)+A(02)*B(20)+A(03)*B(30). The output values stored in the processing elements may then be read out as the processing result associated with the multiplication. For example, values stored in each row of processing elements may be read out sequentially. As another example, values stored in a threshold number of rows may be read out sequentially (e.g., 8 rows, 16 rows, and so on).

### Flowchart

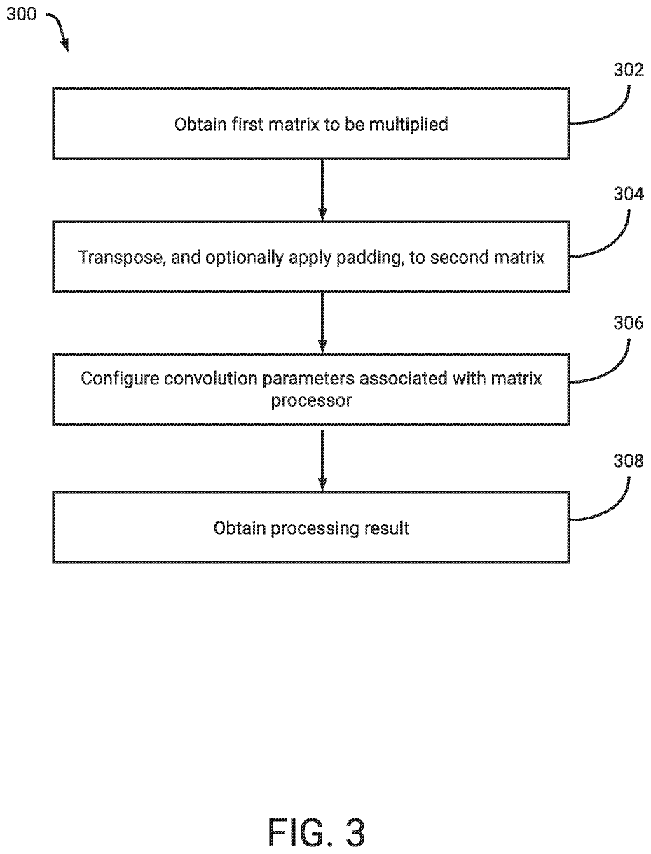

FIG. 3 is a flowchart of an example process 300 for matrix multiplication using a convolution engine. For convenience, the process 300 will be described as being performed by the matrix processing system 100.

At block 302, the system obtains a first matrix and a second matrix to be multiplied. The system may obtain the first matrix and second matrix based on instructions being executed. For example, software being executed by the system may cause the first matrix to be fetched (e.g., from memory).

At block 304, the system transposes and optionally pads the second matrix. The system, as described in FIGS. 1B-2A, transposes the second matrix.

Specifically, the result of the multiplication between the first matrix and the second matrix will represent the first matrix*the second matrix. Thus, the second matrix may be specified as the latter of the matrices in the order of multiplication. Additionally, based on the size associated with the second matrix the system may pad the second matrix as described above.

At block 306, the system configures convolution parameters associated with a matrix processor. As described above, the system may set the parameters to indicate a filter size of 1×1. In some embodiments, the system may perform multiplication using matrices with multitudes of channels. In these embodiments, the system may perform the multiplication as described above over individual channels. Thus, these channels may be processed separately.

At block 308, the system obtains a processing result. As described in FIGS. 2A-2C, the system formats or otherwise organizes the values of the first matrix and second matrix such that they can be provided as weight data and input data to the matrix processor. Over one or more cycles the multiplication may be performed, and a processing result obtained.

### Vehicle Block Diagram

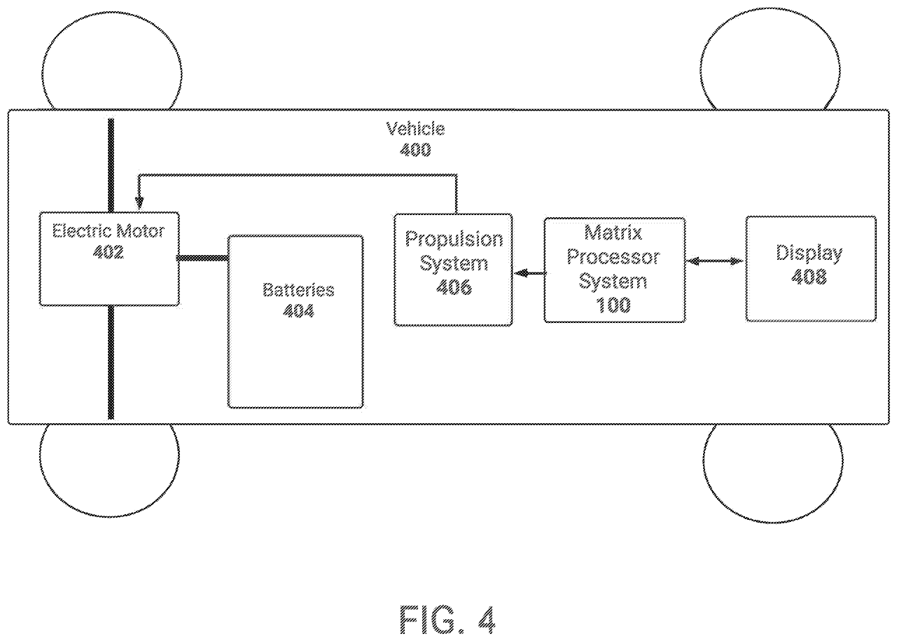

FIG. 4 illustrates a block diagram of a vehicle 400 (e.g., vehicle 102). The vehicle 400 may include one or more electric motors 402 which cause movement of the vehicle 400. The electric motors 402 may include, for example, induction motors, permanent magnet motors, and so on. Batteries 404 (e.g., one or more battery packs each comprising a multitude of batteries) may be used to power the electric motors 402 as is known by those skilled in the art.

The vehicle 400 further includes a propulsion system 406 usable to set a gear (e.g., a propulsion direction) for the vehicle. With respect to an electric vehicle, the propulsion system 406 may adjust operation of the electric motor 402 to change propulsion direction.

Additionally, the vehicle includes the matrix processor system 100 which is configured to perform matrix multiplication using a convolution engine (e.g., matrix processor 110). The matrix processor system 100 may process data, such as images received from image sensors positioned about the vehicle 400 (e.g., cameras). The matrix processor system 100 may additionally output information to, and receive information (e.g., user input) from, a display 408 included in the vehicle 400.

### Other Embodiments

All of the processes described herein may be embodied in, and fully automated, via software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence or can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and engines described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

1. A matrix processor comprising a plurality of processing elements arranged as a grid, wherein the matrix processor is configured to:
receive a first matrix and a second matrix, wherein the first matrix is to be multiplied by the second matrix;
transpose the second matrix;
organize the second matrix into a plurality of columns, wherein each column is a row of the second matrix; and
over one or more cycles, sequentially provide the columns of the second matrix and the rows of the first matrix to the processing elements, wherein a processing result is stored in the processing elements.

2. The matrix processor of claim 1, wherein an order of the multiplication is the first matrix*second matrix.

3. The matrix processor of claim 1, wherein the second matrix is padded based on a size associated with the second matrix.

4. The matrix processor of claim 1, wherein the matrix processor is a convolution engine, and wherein convolution parameters are set for the matrix processor.

5. The matrix processor of claim 4, wherein the convolution parameters indicate filters of 1×1 size.

6. The matrix processor of claim 5, wherein the convolution parameters indicate a single input channel and/or output channel.

7. The matrix processor of claim 1, wherein the array of processing elements is non-systolic.

8. The matrix processor of claim 1, wherein each processing element stores an element of the multiplication.

9. The matrix processor of claim 1, wherein the processing elements are configured as multiply-accumulate units (MAC units).

10. The matrix processor of claim 1, wherein the second matrix is a subset of a large matrix, and wherein the larger matrix is separated into a plurality of subsets based on a size of the second matrix exceeding a size associated with the processing elements.

11. A method implemented by a matrix processor comprising an array of processing elements, wherein the method comprises:
obtaining a first matrix and a second matrix, wherein the first matrix is to be multiplied by the second matrix;
transposing the second matrix;
organizing the second matrix into a plurality of columns, wherein each column is a row of the second matrix; and
over one or more cycles, sequentially providing the columns of the second matrix and the rows of the first matrix to the processing elements, wherein a processing result is stored in the processing elements.

12. The method of claim 11, wherein an order of the multiplication is the first matrix*second matrix.

13. The method of claim 11, wherein the second matrix is padded based on a size associated with the second matrix.

14. The method of claim 11, wherein the matrix processor is a convolution engine, and wherein convolution parameters are set for the matrix processor.

15. The method of claim 14, wherein the convolution parameters indicate filters of 1×1 size.

16. The method of claim 15, wherein the convolution parameters indicate a single input channel and/or output channel.

17. The method of claim 11, wherein the array of processing elements is non-systolic.

18. The method of claim 11, wherein each processing element stores an element of the multiplication.

19. The method of claim 11, wherein the processing elements are configured as multiply-accumulate units (MAC units).

20. The method of claim 11, wherein the second matrix is a subset of a large matrix, and wherein the larger matrix is separated into a plurality of subsets based on a size of the second matrix exceeding a size associated with the processing elements.
